(19) United States
(12) Patent Application Publication
(10) Pub. No.: US 2015/0040556 A1
(43) Pub. Date: Feb. 12, 2015

(54) ZERO EMISSIONS POWER PLANT

(71) Applicant: ARVIND A. DAYA, FAYETTEVILLE, GA (US)

(72) Inventor: ARVIND A. DAYA, FAYETTEVILLE, GA (US)

(21) Appl. No.: 13/964,170

(22) Filed: Aug. 12, 2013

(51) Int. Cl. F03B 17/04

(52) U.S. Cl. CPC F03B 17/04
USPC 60/496

(57) ABSTRACT

An engine with low rpm and high torque from a combination of gravity forces and the inherent buoyancy as energy of a hollow body is formed immersed in a fluid. The engine includes pair of track system as parallel conveyers with belts or chains and gears that's fixed to a frame that's repeatedly displaces water, two methods used achieving the same objective firstly, sealed cylinders with gears on conveyer, said conveyer frame has external and internal single edge tracking gear cut segment that generate the gravity and buoyancy continuously, the second method triangular prism bellow chambers attached to said conveyer operated by a rail system to collapse and expend thereby combination of buoyancy and gravitational forces causes movement of sprocket chain thus rotate the sprocket gears which is used as a power plant, multiple engines can be deployed in a large tall tank, lake, and ocean as clean energy farm.

### FIELD OF INVENTION

The present invention relates generally to reducing the use of the conventional combustion engine, which primarily functions on diesel or gas (petrol) fuel, as a power plant (engine or machine) on large applications such as largest container ships and large capacity electrical generator sets. To eliminate the use of fossil fuels in large combustion engines which is economically and environmentally causing havoc with zero pollution engines that is powered by gravity and buoyancy.

### BACKGROUND OF THE INVENTION

Among the conventionally known combustion engine-driven large container ships and tankers and large capacity generator sets, operated by the use of fossil fuel are ones which have a driven shaft connected to a combustion engine directly or through a gearbox to propel the huge load, More specifically as mentioned earlier each of these equipment use an enormous amount of fuel to power them as a result cumulatively produce large quantity of CO₂. Consequently, in such an environment, global warming has a huge impact on the ecosystem.

There is a general need for alternative sources for large power plant (engine) which is inexpensive to operate and efficient in operation. Prior art power plants tend to be highly inefficient and lose a great deal of the energy generated before that energy can be utilized. With energy consumption hitting record levels, there is global need for clean sources of power plants (engine) that can generate electricity, power large container ship, replace coal and nuclear side of the electrical power generating plants furthermore with excess electricity hydrogen can be produced as fuel source to power our cars, airplanes, homes and industries directly or indirectly.

The electric power grid is increasingly complex and the matching of power generation supply with power usage is a critical element in maintaining stability in operation. This issue is becoming more complicated with the addition of alternative energy generation sources such as wind power and solar power which have inherent issues with consistency of power production not to mention the losses in conversion of frequency and DC to AC. There is a need for utility scale energy generation without the use of fossil fuel or nuclear. The present invention has a potential to do just that on large scale.

### SUMMARY OF THE INVENTION

In order to accomplish the above-mentioned challenges, the present invention provides a new method, an engine that produces the high torque required by the power-plant, thus replacing the conventional combustion engine that powered the said power-plant, which comprises of: a gravitation powered power plant and an associated method, a combination of gravity force and the inherent buoyancy force conveyer type engine designed to mechanically operate in large tall water tanks to power high rise building, or as buoyancy farm on land or stream of water, large containerships with modifications to ships hall, floating electric plants in lakes, sea and ocean.

In the present invention the power plant (engine) is assembled with large chambers on set of conveyers. Each of the chambers displaces liquid, preferably water (in freezing climates antifreeze solution added to water) with aid of the mechanical conveyer system (engine) that is used to generate motion through buoyancy. Each of the said buoyant chambers cumulatively produces enormous amount of force to overcome the designed torque to propel the huge load. Additional electronic controls could be added to monitor and maintain the said power plant.

There are two method in the present invention to overcome a given turning load for generating to propel torque which employs a combination of water buoyancy force and gravity force to generate electricity or propel a large ship using the mentioned mechanical conveyer engine to displace water in the deep part of a large tall water tank or on lakes, sea and ocean as floating mechanical conveyer power plant (engine) to generate electricity thus buoyancy force is generated continuously 24/7 as multiple unit are combined as a buoyancy farm.

The representative structure of the said chamber type of a present mechanical invention on the conveyer system is to accomplish the above objective is as follows;

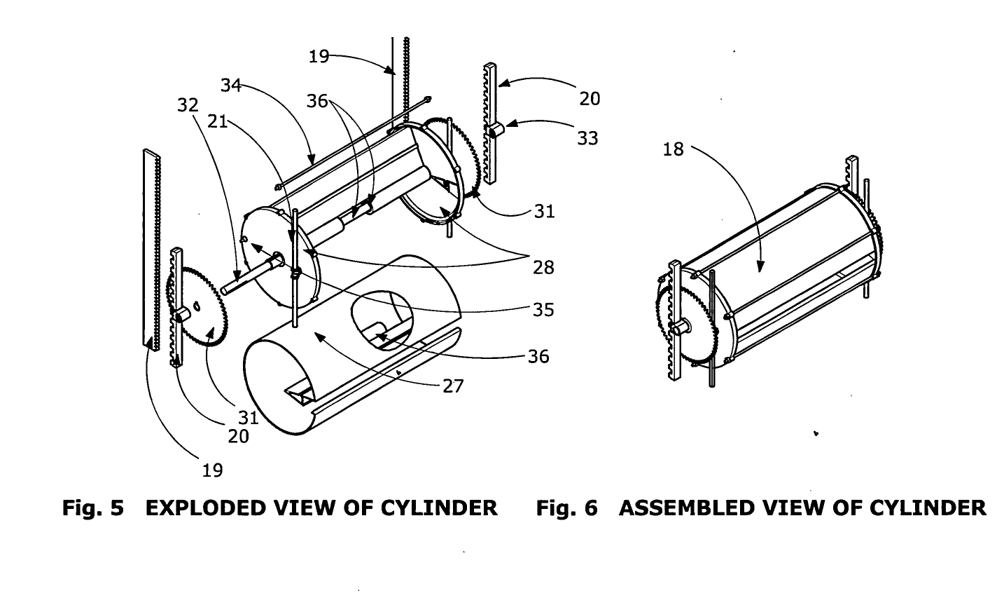

First method is each said cylinder chamber of a uniform size is mounted on a track system as parallel conveyers with dual industrial timing belts and gears with shafts mounted on a frame along with dual rail system running parallel to the said timing belts to secure all cylinder chambers to run uniformly and smoothly, the chamber are further tied to the said dual timing belts thus pulling the said timing belts. Each said cylinder chamber is capped at both ends maintaining a sealed cylinder as shown in FIG. 5 and FIG. 6, inside each cylinder is a rotating baffle blade on a shaft between the centres of the two capped ends, which sweeps the cylinder walls in a circular manner operated from the centre of the said cylinder. Both ends of the rotating blade's shaft that's pieced through the center of the capped cylinder is further attached by a set of gears on both sides of the said sealed cylinder chamber frame, which are used for a large gear reduction to overcome water displacement force on cylinder shaft. At a given point on the inner side of the said cylinder wall sector, two walls as a “V” shape are fixed towards the centre shaft forming a triangle shape, one wall of the said two walls has large openings (allowing water to be expelled or entered) at several locations on the wall opening. The base of the triangle is the outer circumference of said cylinder sector that has an opening of large holes to discharge and take in water, which occupies approximately five to seven present of the cylinder circumference depending upon the design. The bottom tip of the “V” shape two sided walls of the triangular meets at the centre of the cylinder shaft, where the “V” tip of the walls supports a bushing in form of a hinge in which the blade and shaft rotates. The said baffle blade sweeps (rotating blade is neoprene sealed on the perimeter of the blade as well as the hinge as it sweeps to prevent seepage) all the water thus creates vacuum in the said cylinder thereby is filled with air as the said shaft rotates the said rotating blade. The said air is cycled in a loop as one cylinder on top of conveyer is filled with water simultaneously another cylinder at bottom of the conveyer is filled with air causing buoyancy force. The baffle sweeping blade and the centre bushing for the cylinder shaft perform as a piano hinge where a said shaft is fixed on to the sweeping blade causing the blade to sweep the cylinder wall clockwise and counter clockwise until it comes in contact with the said fixed “V” shape walls causing water to be expelled or creating a vacuum taking in air through the said loop. It is understood from the above mechanism that expelling water from the cylinder chamber and creating suction that is defused as the loop air enters cylinder has direct implication on buoyancy force by displacing water and balancing the forces.

It is further understood viewing the drawings that each of the fully assembled large cylinders described above is attached to an upright conveyer type system. The top shaft of the conveyer and the bottom shaft are on a two sets of gears fixed to a frame. The industrial timing belts of the said conveyer system are fixed to each of the said mechanical cylinders spaced out evenly around the entire route of the said industrial timing belt. As the conveyer turns, the cylinder chambers are riding on a separate rail to maintain a smooth and steady movement as they are circulating along with the industrial timing belt that is pulled by the said cylinders. The said timing belt is pulled down with aid of the water filled cylinders by gravity force on one side at same time the water displaced cylinders on the other side of the conveyer been pulled opposite direction as buoyancy force thus cumulatively the said timing belt exert turning force on the gears. Identical copies of the said conveyer system explained above can be duplicated and combined thus coupled as one shaft to overcome the designed torque as a farm of buoyancy and gravity energy. As each conveyer system is combined, top or bottom shaft of the each and every conveyer is connected as a common shaft directly turning to propel a ship or a large generator.

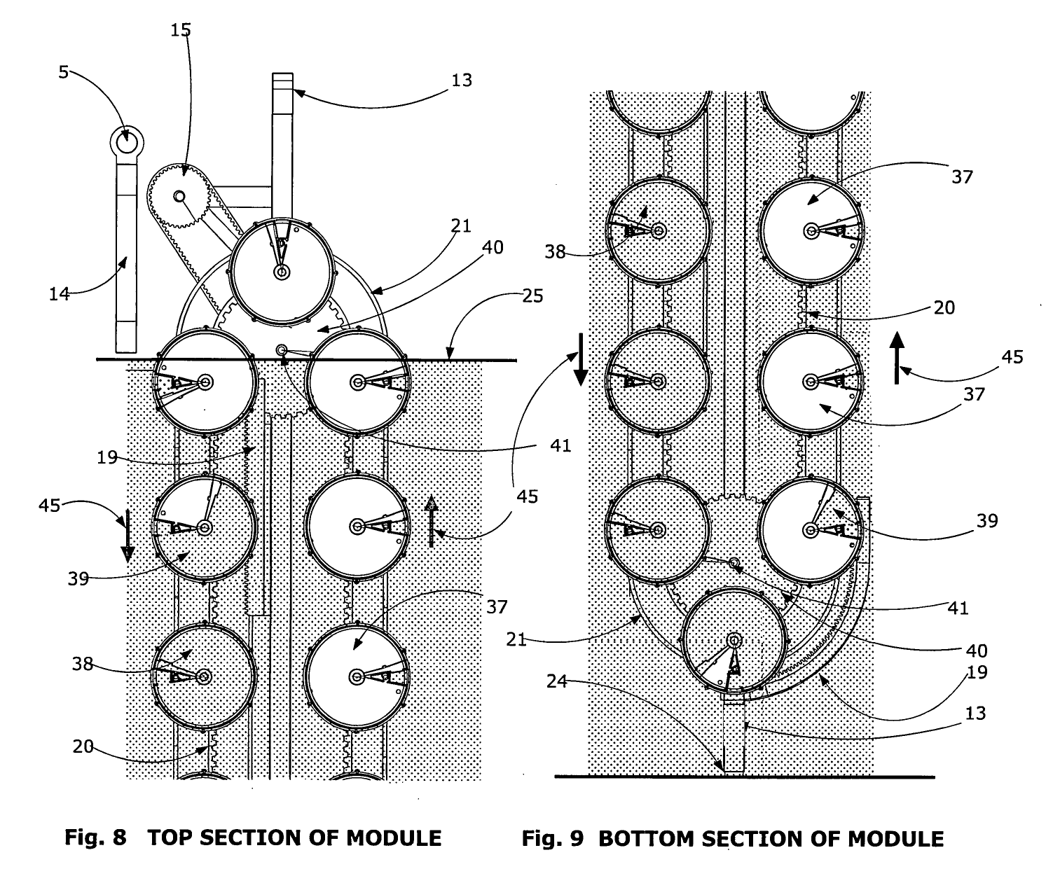

The mechanical function of the said cylinder is caused by a set of gears fixed to the cylinder rotational baffle blade shaft. As the each cylinder is riding on the said conveyer they are passing a stationary gear single edge tracking gear cut segment fixed to the conveyer frame's top and the bottom section of the conveyer system. Each of the said mechanical cylinders, as they make their way pass either the top or the bottom said stationary track gear cut segment (single edge tracking gear cut segment mounted of the conveyer frame) the gears on each cylinder makes contact with the said stationary track gear cut segment thereby the cylinder's sweeping baffle blade on a shaft turns since the gears are fixed to the cylinder shaft making contact with the stationary track gear segment as each cylinder travels on the said conveyer as shown in FIG. 8 and FIG. 9

The main difference between the top stationary track gear segment (Internal single edge track segment gear) is the said track gear teeth is on the inside of the conveyer causing the gears on the said mechanical cylinder to turn counter clockwise causing the rotating baffle blade shaft on the cylinder to turn allowing water to enter the cylinder and expel the air into the air loop circuit as the said conveyer turns counter clockwise. The bottom stationary gear cut segment (External single edge track segment gear) has the gear teeth on the outer side of the said conveyer causing the gears of the said pair of gears on the said mechanical cylinder to turn clockwise causing the rotating baffle blade shaft on the cylinder to turn expelling water and taking in air from the said cylinder as the conveyer turns counter clockwise as in this case.

The following is detail travel journey of each and every said mechanical cylinder chamber by the engine's conveyer cycle thus producing the rotational gravitational force, cumulatively each cylinder produce enormous amount of buoyancy force to overcome the designed torque to propel the shaft. As the each cylinder filled with water makes it way moving downwards going counter-clock wise on the said conveyer, thus as the cylinder reaches the contact point at the lower stationary track gear segment and makes contact thus starts turning the gears on the cylinder, as gears on the cylinder turns the rotational baffle blade shaft sweeping all of the water out of the cylinder causing a displacement of the water, whereby filled with air, at this point the gears on the cylinders locks. This mechanical action causes a buoyancy force that forces the cylinder upwards thus all the cylinders above that mechanical cylinder that are going upwards cumulatively have an enormous force on the conveyer industrial timing belt since all are filled with air on buoyancy side of the said conveyer engine. As the said cylinder reaches the top of the conveyer above the water surface and makes contact with the top stationary gear cut segment the cylinder gears get unlock mechanism mounted on the conveyer frame the gear and shaft of the cylinder start turning taking in water into the said cylinder causing it to apply gravity force. This process is repeated continuously as each cylinder goes through the cycle thus applies a pulling force on the industrial timing belt of the conveyer engine to propel the said timing gear shaft to overcome the required torque of the a load.

In the second method as shown in FIG. 11, a TPBCC (triangular prism bellow collapsible chamber) is used to achieve a similar objective of generating buoyancy force in water whereby turning a sprocket gear shaft, except in this design the objective is to reduce drag whereby to increase efficiency along with two sets of rail system that is used, one outer set of rail system is to expand and collapse each TPBCC, the other inner rail (not shown) runs along with the sprocket chain in close proximity to maintain a steady movement of the TPBCC. Each TPBCC is of a uniform size that is mounted on a dual track system as parallel conveyers with sprocket chains and where sprocket gears has shafts mounted to a said conveyer frame, these chambers are triangular prism shape with bellow at both ends and the base of the TPBCC, so that they can be collapsed at the base of the triangle shape. The lower side is the base of the said TPBCC that is expendable with aid of the rail system to control the expansion to generate buoyancy force and contraction to accelerate gravity force as each TPBCC makes their way through the cycle of the conveyer module. Each TPBCC is identical to apply uniform force. The vertex of each TPBCC is designed to cut through the water to reduce drag as each TPBCC is cycled by the conveyer.

The following is detail travel journey of the said TPBCC by the engine's conveyer cycle thus producing the rotational torque on the sprocket gear of the conveyer module. The gravitational force on one side of the said conveyer and buoyancy force on the other side of the same conveyer at the same time, cumulatively each cylinder produce enormous amount of buoyancy force on the said buoyancy side of the conveyer to overcome the designed torque to propel said gear whereby the shaft to the load, since the weight of the each TPBCC cancels each other's out on both sides of the conveyer and their weight are equally balanced on both sides. As each of TPBCC makes their way on two sets of rail system mounted on the conveyer frame, one inner set of rail is mounted on the conveyer frame along the sprocket chain route is to guide and pull the sprocket chain by the each TPBCC that attached to sprocket chain conveyer. The outer rail is mounted on the frame of the said conveyer guides and maintains each TPBCC's expansion and contraction continuously, furthermore it has a branch rail on the outer rail to keep the TPBCCs collapsed to shut the said conveyer engine down gradually, the said branch rail is controlled from the top. The expansion and collapsing of the TPBCCs is repeated continuously as each TPBCC goes through the cycle thus applies force on the rotating sprocket gears of the conveyer engine thus propel the shaft. Each TPBCC make their way pass the lower sprocket gears on the conveyer system going back up. As each TPBCC begin to go up expanded by the outer rail system thereby guides each TPBCC to maintain expanded form generating a buoyancy force as water is displaced in each of the TPBCCs going up to the top of the said conveyer is turn around by the sprocket gear on the conveyer. As the TPBCCs make their way down the said outer rail collapses them thus reducing the drag on the conveyer engine causing a gravity fall of the TPBCC. Cumulatively buoyancy force of all the expended TPBCC has an enormous force on the sprocket chain of the conveyer system as a result the sprocket gear has very high torque on the shaft. This process is repeated continuously as each TPBCC goes through the cycle thus applies a pulling force on the sprocket chain of the conveyer engine to propel the sprocket gear shaft. In order to start the conveyer module a manual crank handle is installed on top (not shown) to crank the sprocket gear and the branch rail disengaged, to shut the conveyer module down a branch rail is provided to disengage the expansion of the TPBCC.

### BRIEF DESCRIPTION OF THE DAWINGS

A preferred embodiment of the present invention is described below with reference to the accompanying drawings, in which:

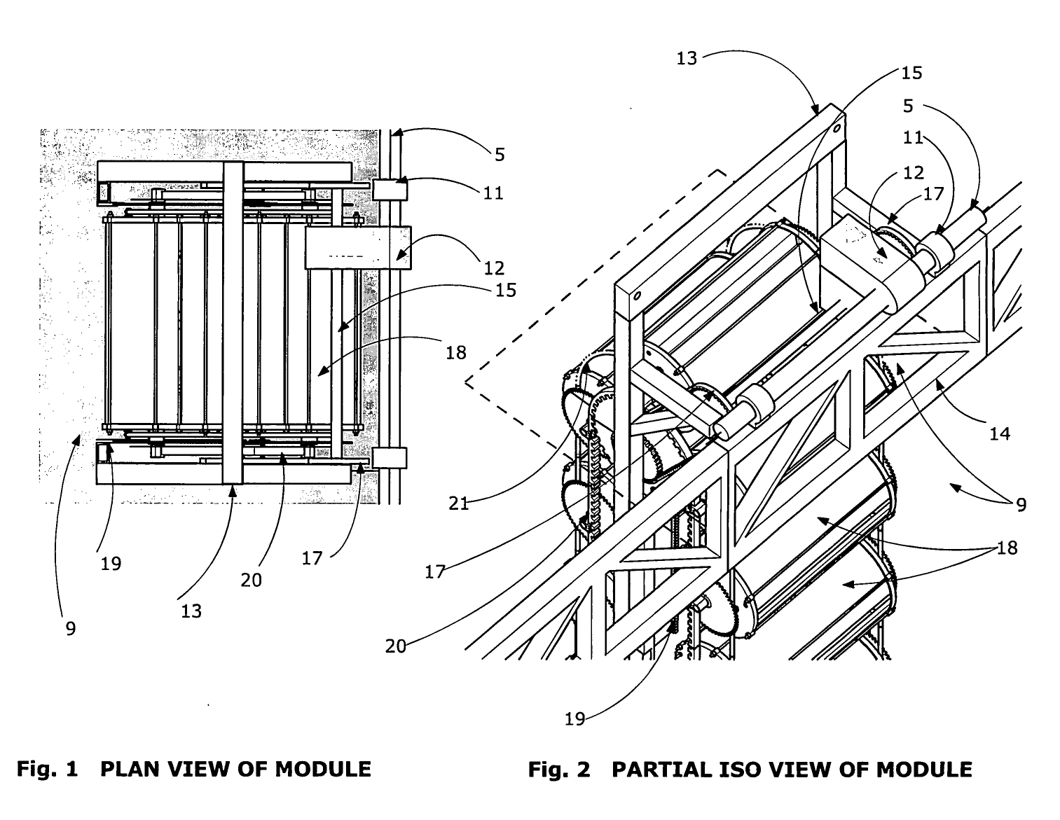

FIG. 1 is a plan view of the module of a power plant.

FIG. 2 is a partial isometric view of the top section of the module showing transfer belt and oil bath gear driving module shaft attached to power plant structure to facilitate module detachment.

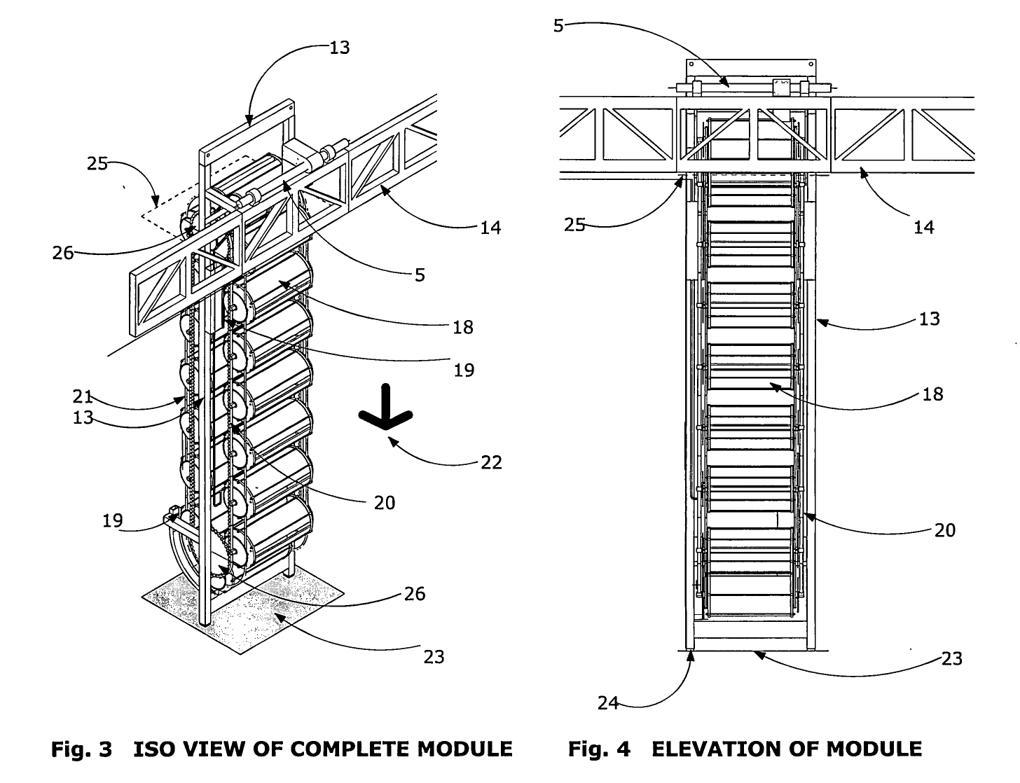

FIG. 3 depicts an isometric view of the module where an industrial timing belt and gear is used as conveyers that could function with sprocket chain and sprocket gear as well, and be expandable to accommodate a given load amongst the farm of modules.

FIG. 4 illustrates an elevation of the module.

FIG. 5 illustrates an exploded view of the cylinder where larges gear are used, should additional torque be require on larger volume cylinders a set of spur gears could be used riding on the a cut track gear segment to overcome the torque, furthermore a tow cable system be installed in the cylinder inner circumference of the walls to pull the baffle blade as it sweeps the cylinder to displace water with the aid of the said spur gears shaft winding and releasing the said cable.

FIG. 6 illustrates an embodiment of an assembled cylinder with industrial timing belt attached.

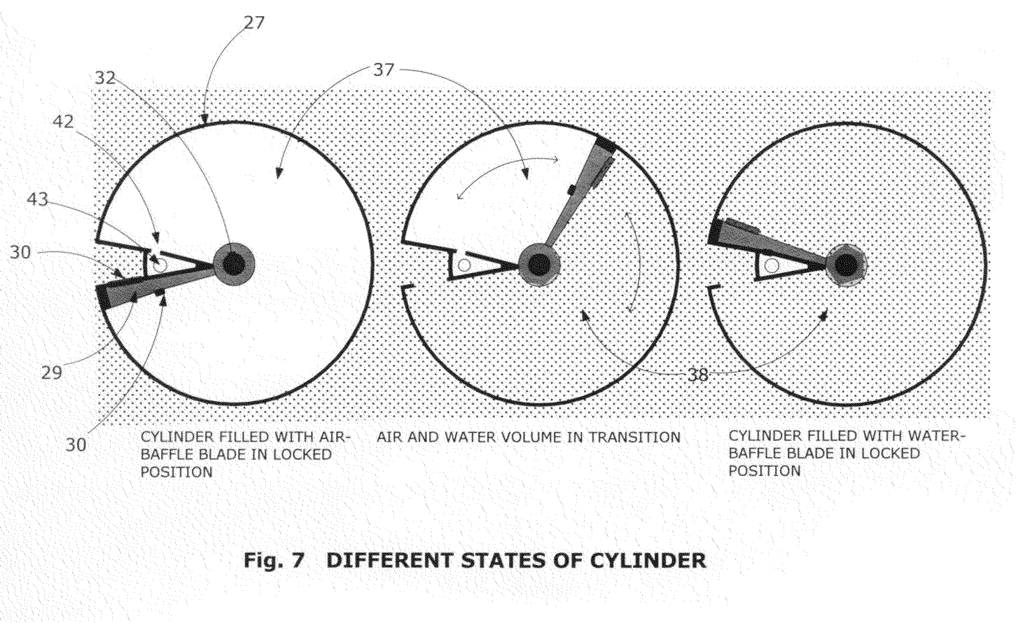

FIG. 7 illustrates an embodiment of different stages of cylinder during the displacement of water and air and intake of water and air by the baffle in the cylinders “V” shape cavity to support the baffle shaft.

FIG. 8 depicts a top section of the module of an oval path dual drive track system with internal single edge track gear segments mounted to the frame of the conveyer module. The said internal track gear segments can be curved if need.

FIG. 9 depicts a bottom section of the module of an oval path dual drive track system with external single edge track gear curved segments mounted to the frame of the conveyer module, furthermore a rectangular path driven with dual track system can also used to achieve the same objective (not shown).

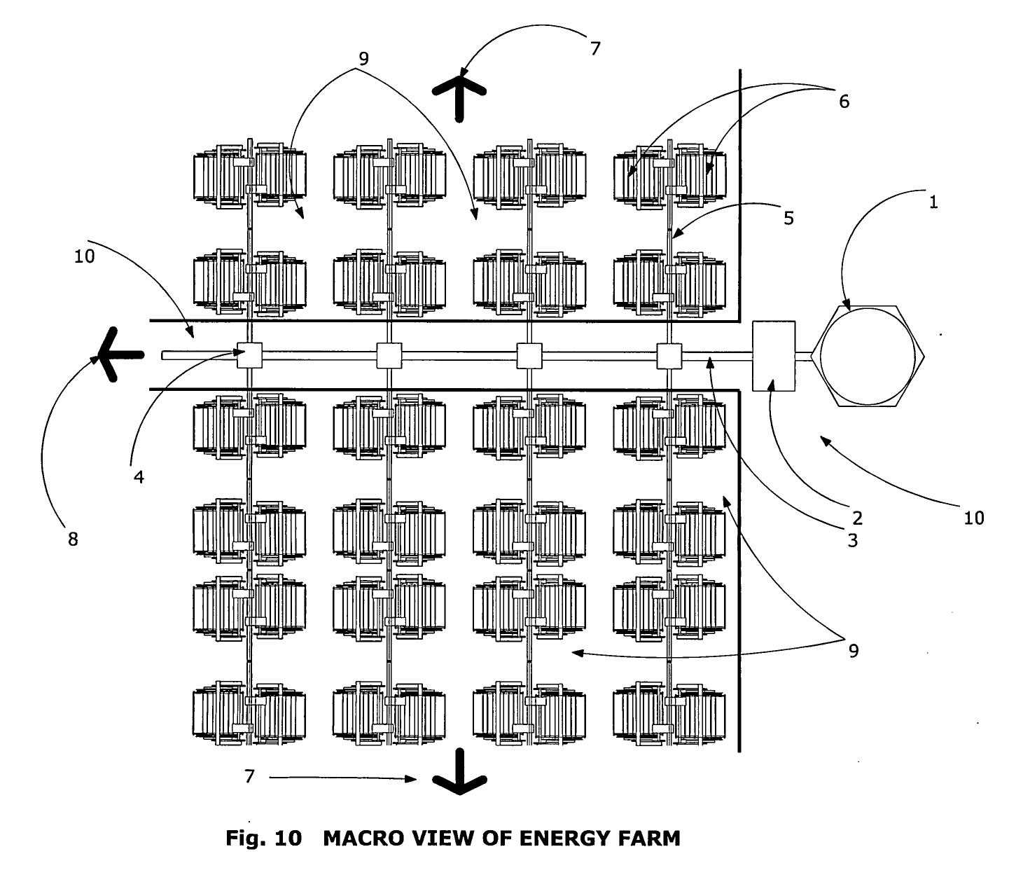

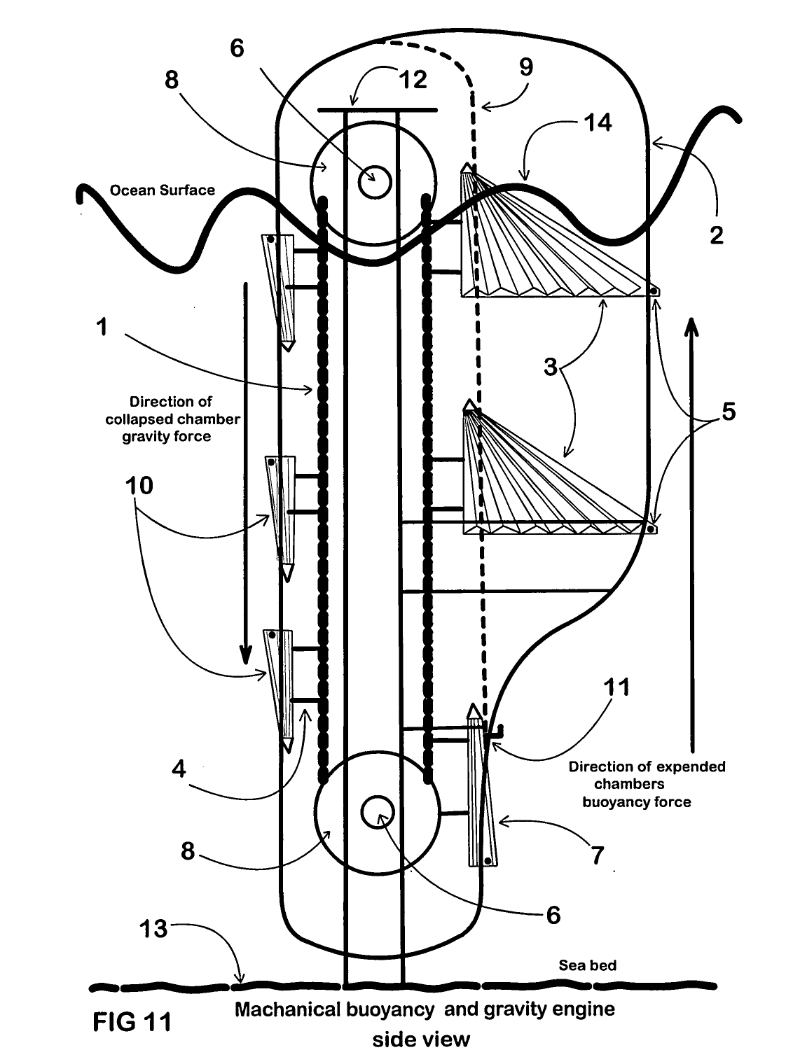

FIG. 10 depicts macro view of the energy farm that can be deployed for many applications.

FIG. 11 depicts a mechanical buoyancy and gravity module with sprocket gear and sprocket chain that could use industrial timing belt and gear instead and are kept under tension.

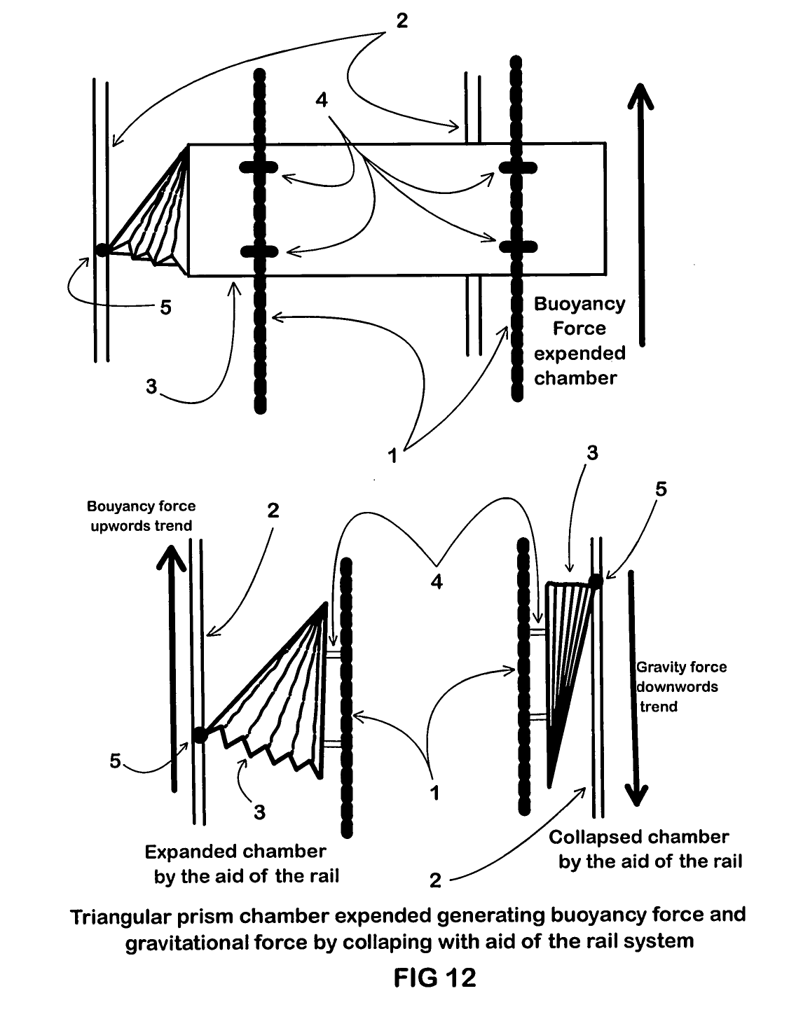

FIG. 12 depicts triangular prim expending generating buoyancy force and gravitational force by collapsing with aid of the rail system with minimum drag.

### DETAILED DESCRIPTION OF THE PREFERRED EMBODIMENTS

Hereinafter, referring to the drawings, preferred embodiments of the invention are described in detail in an exemplifying manner. The size, materials, shapes and correlative positions of the structure parts as sets forth in the embodiments below can be modified properly according to the various conditions and terms, and if there is no special description, the scope of this invention is not intended to be limited only to those.

### First Set of Embodiment

Hereinafter, the first embodiment of the invention is described with reference to the drawings FIG. 1 to FIG. 10 showing the entire structure of the said propulsion of a power-plant (engine) in a first embodiment using cylinders and a MCSM (mechanical conveyer system module) 13 to displace water with the aid of gears 31 and single edge track gear segments 19 in the deep part of a large tall water tank, on lakes, sea and ocean thus buoyancy force is generated continuously 24/7, cumulatively multiple unit, 6 and added said cylinders 22 can be assembled as buoyancy farm.

A MCSM 13 of an oval path driven with dual track conveyer system mounted parallel in order to support long cylinders chambers 18 on the said MCSM 13 cylinders are uniform size mounted on the said track system as parallel conveyers with dual industrial timing belts 20 and gears 41. A single edge gear track segment 19 mounted to a frame of the MCSM 13, along with dual rail system not shown running parallel to industrial timing belt thus secure all cylinder chambers to run uniformly and smoothly on the said rail track, as the said cylinders make their way pass each said gear track single edge segment 19 to turn cylinder shaft 32 and the baffle blade 29 in each chamber, water is displaced or water is taken into the cylinders. The cylinders are further tied to the dual industrial timing belt 20, as the said cylinders 18 are pulling the said industrial timing belt 20 kept under tension thereby turning the timing belt gears 40.

As discussed above, the present invention relates to a conveyer module or an engine for generating to propel torque which employs a combination of buoyancy force and gravity force whereby generate electricity or propel a large ship. Referring to the drawings, as shown in FIG. 1 plan view of the module demonstrate a small footprint.

Referring now to FIG. 2 a partial top view of the MCSM 13 in which a detachable gear assembly in oil bath 12 is to disengage from the branch shaft 5 without interruption of the power-plant farm during servicing or replacing the MCSM 13.

Referring now to FIGS. 3 and 4 a complete view of the MCSM 13 as part of the group as a farm of MCSMs that each said MCSM 13 can be independently serviced and or replaced without stopping the entire power-plant, furthermore additional cylinders can be added 22 in the design of the MCSM 13 thus increasing the turning torque of the main module shaft 40. The said MCSM 13 as a single unit in a tall water tank can be applied to propel an electrical generator or a water pump etcetera with a few modifications. The said single unit of MCSM 13 to propel equipment can be turned on with aid of a manual crank not shown on the top of a gear shaft 15 and turned off with aid of the lower single edge track gear attachment 19 of the MCSM that is temporary manually disengaged from the top not shown thus preventing the gear 31 from turning the baffle blade and displacing water. The said MCSM 13 would gradually come to a halt.

Referring now to FIGS. 5 and 6 a exploded view and assembled view respectively, the said cylinders can be made of most material that can withstand pressure and preferably a low density furthermore the cylinders are sealed so water is not allowed in some areas of the cylinders and the rotating baffle 29 is also sealed preventing water to pass as it sweeps through as the shaft 32 rotates. The rotating baffle blade 29 shaft guides is part of the “V” shape walls as a support 36.

Referring now to FIG. 7 Different stages of each cylinder in the cycle of MCSM 13 as they make their way displacing water and taking in water to generate buoyancy and gravity respectively to convey the energy needed to propel main module gear 40. As the cylinder makes its way pass the single edge gear track segment 19 at the bottom of the MCSM 13. The rotating baffle 29 in the cylinder makes its way displacing water thus the rotating baffle 29 that has an enormous force to overcome as larger cylinders are used, this said force can be overcome by additional spur gear not shown added to the large gear 31 thus would have additional torque to overcome the load, furthermore addition tow cables can be installed in the cylinder towards the outer centre along the inner circumference of the said baffle blade tied to the said additional spur gear shaft not shown. The said cylinders attached to the MCSM 13 have a air loop system where all the cylinders on a particular said MCSM 13 have a air port 43 connected to a flexible reinforced hose 21 thus as one cylinder at the lower end of the MCSM 13 displaces water at the same time thus taking in air, this air comes from a similar cylinder on the top of the MCSM 13 that is taking in water and expelling air in a air closed loop system 21 furthermore a pressurized air accumulator is installed in the air loop circuit to offset any unbalances between water and air not shown, to prevent water from entering or air entering in each other's space during any pressure differences between the two said spaces.

Referring now to FIG. 8 and FIG. 9 showing the top section of an oval path driven track system MCSM 13 and the bottom section of the said MCSM 13, where the cylinders 18 are shown to perform in a cordial manner transferring air from the top cylinders 18 as they fill with water generating gravity force and the bottom cylinders 18 displacing water to generate buoyancy force in a uniform manner as the cylinders circle around the said oval track of MCSM 13. In the design of the MCSM 13 the propel energy can be harvested from the top main power shaft 40 as displayed or from the bottom shaft 40 whichever application is appropriate.

Referring now to FIG. 10 is a macro view of energy farm, as identical additional units of MCSM 13 are assembled 7 and combined with aid of branch shaft 5 that would transfer the propel energy to transfer box 4 thus would further transfer, the cumulatively propel energy to the main power shaft 3 thereby to the gearbox 2 to many applications such as a large capacity electrical generator 1, propel a huge ship or produce power for high rise building in metro area.

The following are the reference number to each part in the set of drawing from FIG. 1 to FIG. 10

1 Generator

2 Transmission

3 Main power shaft.

4 Transfer box.

5 Branch shaft connecting module pairs.

6 Independently detachable gravity/buoyancy engine (MCSM)

7 Expansion of modules along the branch shaft.

8 Expansion of branch rows of modules along main shaft.

9 Water pool.

10 Platform.

11 Brackets on steel structure spanning the pool.

12 Detachable gear assembly in oil bath to disengage from branch shaft without interruption to the power plant.

13 Module structure that can independently be hoisted vertically (MCSM).

14 Steel structure spanning over the pool.

15 Secondary module shaft.

16 Gear that engages the secondary module shaft to branch shaft set in oil bath.

17 Transfer belt and gear driving module shaft attached to (13) module structure.

18 Cylinder assembly.

19 Internal or External single edge track gear segment attached to structure (Linear or curved).

20 Main module belt with fixed attachment for cylinder assembly.

21 Flexible air hoses interconnecting cylinder assemblies in closed system.

22 Cylinder assembly sets can be varied in the modules.

23 Pool floor.

24 Anchors to receive modules structure (13).

25 Water level.

26 Primary module industrial timing gear and shaft.

27 Extruded cylinder.

28 End cap.

29 Rotational baffle a blade hinged around cylinder shaft (32)

30 Neoprene seals preventing and maintaining a separation of air and water while the baffle blade sweeps back and forth.

31 Gear attached to blade (29) controlled by gear track single edge segment (19)

32 Cylinder shaft.

33 Fitting to attach cylinder and cylinder shaft as a unit to the industrial timing belt (20)

34 Bolt to secure end caps to cylinder.

35 Fitting connection to flexible hose. (21)

36 Hinge type support system for cylinder shaft with seals to prevent seepage.

37 Air filled space in the cylinder.

38 Water filled space in the cylinder.

39 Cylinder in transition phase between water and air.

40 Main module timing belt gear.

41 Shaft supporting main module timing belt gears attached to module structure (13)

42 Slot allowing passage of air in the air loop circuit.

43 Spur gear and tow cable in the cylinder not shown

44 Pressurized accumulator with flexible hose (21) to supply compressed air to module closed air loop system to offset any unbalances in air pressure not shown.

45 Direction of travel cylinders in motion.

### Other Embodiments

Hereinafter, the second set of embodiment of the present invention is described with reference to the drawings. FIG. 11 is a side view showing the module structure of the said propulsion of a power plant (engine), in a second embodiment FIG. 12 using the mentioned triangular prism bellow collapsible chamber 3 and 10 to displace water with aid of the rail system in the deep part of a large tall water tank, lakes, sea and ocean thus buoyancy is generated continuously 24/7, cumulatively multiple unit can be assembled as buoyancy farm.

A conveyer module of a dual track system mounted in parallel FIG. 11 and FIG. 12, two track system is in parallel in order to support the long TPBCC (triangular prism bellow collapsible chamber) as shown in FIG. 11 and FIG. 12 a prospective view of the said TPBCC that's a uniform size is mounted on parallel conveyer track system with sprocket chains 1, all the TPBCC are further tied to the dual sprocket chains 1 where sprocket gears 8 have shafts 6 mounted on a frame 12 along with secured TPBCC 3 on the displaced water (expended) side going up and the collapsed TPBCC 10 going down on to turn the sprocket gears 8 uniformly and smoothly, all the TPBCC are further tied to the dual sprocket chains 1 to propel the sprocket gears 8. In order to start the said conveyer module a manual crank with a disengaging clutch is attached to shaft 6 on the top of the said conveyer module not shown, to turn the conveyer module off a separate branch rail system 9 is attached operated manually, if engaged the TPBCC will stop expending as it goes up thereby preventing a buoyancy force and gradually come to a stop.

Travel journey of each TPBCC through the cycle of the said dual track conveyer module. As the collapsed TPBCC 10 makes its way down on the said conveyer system that are mounted on a inner rail system not shown that run parallel to the sprocket chain to ride the TPBCC smoothly with a link tied 4 to the sprocket chain 1 pulling the said sprocket chain 1, as the TPBCC 10 reaches the bottom of the frame 12 the said TPBCC 10 turns around and makes its way up on the said conveyer, an outer dual rail system 2 begins to expend the said TPBCC 3 due to floating type bearings 5 used on both side of the TPBCC fixed on the outer end to accommodate any axial wander riding on the said outer dual rail system 2 thus simultaneously gradually expanding the said TPBCC and displacing water. This displacement of water by the TPBCC generates buoyancy force going up, since the prior TPBCCs 3 on the said conveyer has already expanded and maintains the displaced water form with the aid of the outer rail 2 system causing an enormous buoyancy force cumulatively pulling on the sprocket chain 1. As each TPBCC 3 expands at the bottom of the conveyer module at the same time at the top of the conveyer module the TPBCC 10 collapses with aid of the outer rail system, this process is achieved by the said floating type bearings 5 used on both side of the TPBCC outer rail system 2, furthermore compressed air in a loop circuit system is simultaneously expelled by the collapsing TPBCC 10 thus a given quantity of air in the said loop that is pushed back and forth repeatedly without external assistance furthermore with aid of a pressurized air accumulator (not shown) in the air loop system to offset any unbalances in the timing of the said procedure and external pressure.

What is claimed:

1. An engine (machine) is powered by clean energy comprising:
a gravity and buoyancy conveyer type engine designed to mechanically operate in large tall tanks, lakes, sea and ocean:
each mechanical cylinder chamber is sealed that takes in or displaces water at appropriate time with aid of gears at both ends of the said cylinder and a shaft attached to the rotating baffle blade in the said sealed cylinder to create gravity or buoyancy force:
a dual oval path drive track system or rectangular dual path drive track as parallel conveyer engine:
all mechanical cylinder of a uniform size are mounted on dual track system as parallel conveyers along with industrial timing belts under tension that drive the timing gears which are fixed to a module frame at both ends:
said mechanical cylinders are operated by a set of single edge gear track segment fixed to the frame at several location of the conveyer:
said mechanical cylinders are mounted with “V” shape cavity to operate as a stabilizer for the baffle shaft and an exit and ingress point for air and water as the baffle blade operates:
as each mechanical cylinder chamber reaches the top on the conveyer system, water fills that chamber thus air in the closed loop circuit is transferred via a tube from the top chamber that is taking in water to the bottom chamber that is displacing water simultaneously on the conveyer module repeatedly balancing air and water pressure with an air pressurized accumulator in the said closed air loop circuit:
a detachable gear assembly in oil bath is to disengage from branch shaft without interruption to the energy farm:
multiple set of conveyer module system fixed to a common shaft with transfer gearboxes thus cumulatively exert enormous torque as a buoyancy farm.

2. An engine (machine) is powered by clean energy of claim 1 wherein an oval path driven with dual track conveyer system mounted parallel in order to support triangular prism bellow chamber as they collapses and expand simultaneously:
all triangular prism bellow chambers are mounted on a dual track system as parallel conveyers with sprocket gears and sprocket chains that are fixed to a conveyer module frame:
as each triangular prism bellow chamber collapses at the top of the conveyer system the air in that chamber is transferred through a closed air loop circuit system to the bottom triangular prism bellow chamber:
a closed air loop circuit system has a pressurized accumulator attached to balance the external forces and any timing issues of expansion and collapsing of the triangular prism bellow chambers:
as each triangular prism bellow chamber collapses at the top of the conveyer system and as each of the bottom said triangular prism bellow chambers that displaces water as they expand with aid of the rails system:
each set of conveyer module system with a collapsible triangular prism chambers fixed to a common shaft thus cumulatively exerts enormous turning torque to overcome the load continuously as an energy farm:
In order to start the conveyer module a manual crank is provided and to shut the said conveyer module a disengaging branch rail is provided to prevent the triangular prim from expanding.
